(19) United States
(12) Patent Application Publication
(10) Pub. No.: US 2022/0108391 A1
(43) Pub. Date: Apr. 7, 2022

(54) SYSTEMS AND METHODS FOR UTILIZING PROJECT INFORMATION FOR ADJUSTING A CREDIT OFFER

(71) Applicant: Billd, LLC, Austin, TX (US)

(72) Inventor: Christopher Lee Doyle, Austin, TX (US)

(21) Appl. No.: 17/492,253

(22) Filed: Oct. 1, 2021

Related U.S. Application Data
(60) Provisional application No. 63/086,253, filed on Oct. 1, 2020.

(51) Int. Cl. G06Q 40/02; G06Q 50/16

(52) U.S. Cl. CPC G06Q 40/025; G06F 21/31; G06Q 50/16

(57) ABSTRACT

The present disclosure is directed method and apparatus that may automatically adjusting credits that offered to support a project based on received project information. Information received by a computer that evaluates credit adjustments may include a property value, a current amount of debt, a current value of project materials, a current credit amount, and an address associated with the product. Such methods may include using received client information to establish an account credit offer based on the received client information, establish a project credit offer based on reived project information, generate an adjustment multiple when the project credit offer is different than the account credit offer, and change the account credit offer based on the project credit offer and the adjustment multiple.

### CROSS-REFERENCE TO RELATED APPLICATIONS

The present disclosure claims priority benefit of U.S. provisional patent application 63/086,253 filed on Oct. 1, 2020, the disclosure of which is incorporated by reference herein.

### BACKGROUND

### Field of the Disclosure

The present disclosure is generally directed to systems and methods for adjusting a credit offer. More specifically, this disclosure is directed to utilizing project information for adjusting a credit offer.

### Description of the Related Art

Borrowers borrowing money to purchase a property apply for a loan in one of several ways. For example, a borrower may apply electronically through a lender or an individual representing the lender. Loans are available from many different sources, such as traditional banks, private and commercial money lenders. Further, lending institutions, such as banks, have assessed loan risk using credit reports and credit scores. Credit reports are records sent from a credit reporting agency to prospective lenders, employers, and insurers that provide information about the credit standing of a consumer. Credit reporting agencies are companies that gather information about consumers and sell it to creditors, or employers or insurers.

For establishing credit offers, current financial instruments facilitate lenders to evaluate factors like credit score, income, age of credit, outstanding debt, historical payment performances, and asset recovery value related to the borrower. A credit score often refers to a number generated by a statistical model used to objectively evaluate the borrower's credit worthiness (s) (including borrower's income) relevant to making a credit decision. In particular, the borrower's income is money that a borrower or a business receives in return for working, providing a product or service, or investing capital. Income may also derive from a pension, a government benefit, or a gift. Further, age of credit or length of credit history may be referring to how long any account has been open. In addition, the outstanding debt is defined as the total principal and interest amount of a debt that has yet to be paid is of core importance for any company that has used debt financing. The outstanding debt is important because it expresses a dollar amount to be paid before a liability is closed. Further, historical payment performances refer to the pattern or the percentage of payments made in the past related to the borrower. Furthermore, the asset recovery value is the projected value of an asset that can be recovered in the event of liquidation or winding down. The asset recovery value is calculated as the recovery rate times the book value of the asset.

The methods mentioned above are quite useful but are suboptimal due to the narrow focus of borrow and asset attributes and no contribution of property criteria of the borrower. The current financial instruments efficiently evaluate the credit to be given to the borrower. Therefore, there is a need for an improved system and method for implementing adjustments to financial instruments, particularly a method for utilizing property criteria for adjusting a credit offer.

### SUMMARY

The present disclosure is directed to apparatus, methods, and non-transitory computer-readable media that adjust credit offerings based on received project information. In a first embodiment a presently claimed method may include the steps of establishing an account credit offer based on client information and establishing a project credit offer based on project information. Here, the project information may include a project address. This method may also include steps of generating an adjustment multiple if the project credit offer is different than the account credit offer and changing the account credit offer based on the project credit offer and the adjustment multiple.

In a second embodiment, when the present method is implemented as a non-transitory computer-readable storage media a processor may execute instructions out of the memory to establish an account credit offer based on client information, establish a project credit offer based on project information. Here again, the project information may include a project address. The processor may then execute instructions out of the memory to generate an adjustment multiple if the project credit offer is different than the account credit offer and change the account credit offer based on the project credit offer and the adjustment multiple.

In a third embodiment, an apparatus may include a memory and a processor that executes instructions out of the memory to establish an account credit offer based on client information and establish a project credit offer based on project information. This project information may include a project address. The processor may then execute instructions out of the memory to generate an adjustment multiple if the project credit offer is different than the account credit offer and change the account credit offer based on the project credit offer and the adjustment multiple.

### BRIEF DESCRIPTION OF THE DRAWINGS

FIG. 1 illustrates a system 100 for utilizing project information to adjust a credit offer for a borrower

FIG. 2 illustrates a computing device that may communicate with a computer that manages a credit process.

FIG. 3 illustrates a flowchart 300 that includes steps of a method for utilizing project information to adjust a credit offer.

FIG. 4 illustrates a flowchart 400 showing a method for determining an eligibility to receive a credit offer adjustment.

### DETAILED DESCRIPTION

The present disclosure is directed method and apparatus that may automatically adjusting credits that offered to support a project based on received project information. Information received by a computer that evaluates credit adjustments may include a property value, a current amount of debt, a current value of project materials, a current credit amount, and an address associated with the product. Such methods may include using received client information to establish an account credit offer based on the received client information, establish a project credit offer based on reived project information, generate an adjustment multiple when the project credit offer is different than the account credit offer, and change the account credit offer based on the project credit offer and the adjustment multiple.

A computer-implemented method for utilizing property criteria to adjust a credit offer may include the steps of establishing an account credit offer based on client information, establishing a project credit offer based on project information. This project information may include a project address. This method may also include generating an adjustment multiple when the project credit offer is different than the account credit offer and increasing the account credit offer based on the project credit offer and the adjustment multiple. For example, for contractor Alex, with tax id—779, DOB—4/5/1789, credit score—826, credit required $9,000,000, and a residential property at 31 King Street, Chicago, with project materials to be installed for $10,000,000 and based on the credit requirement of $9,000,000 and property material evaluation of $10,000,000, an additional credit offer adjustment of $1,000,000 is made.

The project address may include the address for which assets purchased by the credit will be installed in one embodiment. Here, the assets may include building materials. For example, for Alex, the project address is a residential property at 31 King Street, Chicago, with project materials to be installed for $10,000,000.

Information associated with the project may include a set of property attributes. In one embodiment, these property attributes may include one or more of property value, property type, property use, schedule of improvements, and eligibility for adjustments. For example, for Alex, the property type is residential.

A project credit offer may be based on a summation of a plurality of projects. For example, for Alex, the summation of a plurality of projects is $100,000,000.

Methods consistent with the present disclosure may include the steps of recalculating the project credit offer based on the addition of a new project. For example, for Alex, with a new project of $5,000,000, the project credit is recalculated to $15,000,000 by adding the new project cost of $5,000,000 to the original $10,000,000.

A step for establishing an account credit offer may be based on contractor inputting information. For example, for Alex, the account credit offer is made at $9,000,000. The information input by the contractor may include one or more of a tax ID number, business owner information, date of birth, a credit report, a business report, and an address. For example, for Alex, with tax id—779, DOB—4/5/1789, credit score—826, credit required $9,000,000, and residential property at 31 King Street, Chicago, with project materials to be installed for $100,00,000.

A step for establishing an account credit offer may be based on an evaluation of the contractor inputting information exceeding a pre-set minimum threshold. For example, for Alex, based on the credit requirement of $,9,000,000 and property material evaluation of $100,00,000, an additional credit offer adjustment of $1,000,000 is made.

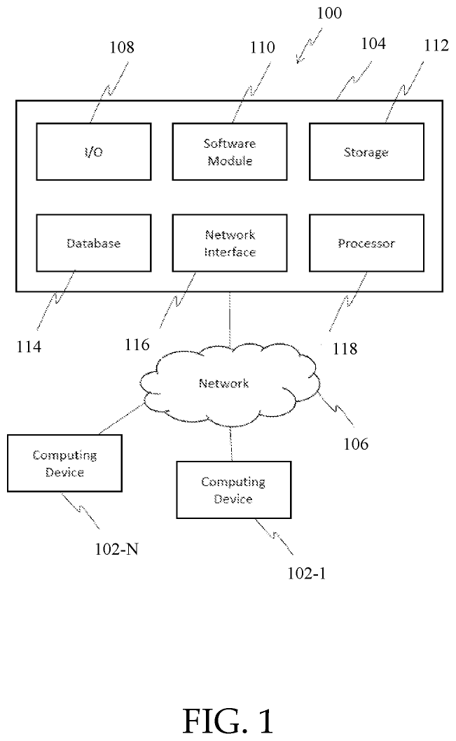

FIG. 1 illustrates a system 100 for utilizing project information to adjust a credit offer for a borrower. For example, a credit offer would mean a first party would offer to pay for materials to a second party for payments overtime plus interest. The system 100 may comprise one or more computing devices 102-1 . . . 102-N, a processing system 104, and a network 106. It can be noted that one or more computing devices 102-1 . . . 102-N may be communicatively coupled to the processing system 104 via the network 106. It can be noted that the term borrower may be used interchangeably as a user or a contractor or general contractor or sub-contractor, or a client.

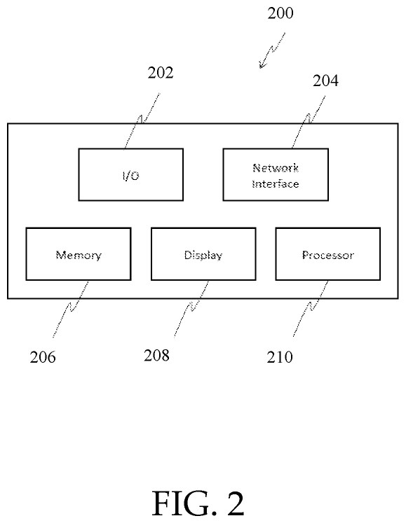

The one or more computing devices 102-1 . . . 102-N may be a computing device, desktop computer, laptop, smartphone, tablet, computer, smart speaker, smartphones, other wireless digital/cellular devices, or I/O devices. It can be noted that one or more computing devices 102-1 . . . 102-N may be referred to as a computing device 102, hereinafter. The computing device 102 may comprise an input device and an output device. The input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Devices allow voice recognition and inputs, including, e.g., Microsoft KINECT, SIRI for iPhone by Apple, Google Now, or Google Voice Search. Additional mobile devices have both input and output capabilities, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), or force-based sensing technologies. Some multi-touch devices may allow two or more contact points with the surface, allowing advanced functionality, including, e.g., pinch, spread, rotate, scroll, or other gestures. Further, the computing device 102 could be an optional component and would be utilized in a situation in which the paired wearable device is utilizing the computing device 102 as additional memory or computing power or connection to the network 106. It can be noted that the computing device 102 may be used by system administrators or by client users such as property owners, contractors, sub-contractors, borrowers, and auxiliary users such as financial institutions and underwriters. It can be noted that the computing device 102 may be explained in conjunction with FIG. 2.

Further, the network 106 may be implemented for connecting the various devices in the system 100. Further, the network 106 may be coupled to one or more computing devices 102-1 . . . 102-N and the processing system 104. Further, the network 106 may be a wired or a wireless network. The network 106, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art. The network 106 may allow ubiquitous access to shared pools of configurable resources and higher-level services that can be rapidly provisioned with minimal management effort, often over the internet, and relies on sharing of resources to achieve coherence and economies of scale, like a public utility, while third-party clouds enable organizations to focus on their core businesses instead of expending resources on computer infrastructure and maintenance. The network 106 may also use standard architecture and protocols as understood by those skilled in the art, such as, for example, a packet-switched network for transporting information and packets in accordance with a standard transmission control protocol/Internet protocol (“TCP/IP”). Additionally, the system 100 may utilize any conventional operating platform or combination of platforms (Windows, Mac OS, Unix, Linux, Android, etc.) and may utilize any conventional networking and communications software as would be understood by those skilled in the art. Additionally, the network 106 may be communicatively coupled to the one or more computing devices 102-1 . . . 102-N and the processing system 104 to facilitate the system 100 for utilizing project information to adjust a credit offer.

Further, to protect data of the borrower, such as sensitive user financial and personal identification data, government data related to the construction or site plans, other confidential data, and to comply with state and federal laws pertaining to the protection of financial and personal identification data, an encryption standard may be used to protect files from unauthorized interception over the network. Any encryption standard or authentication method as may be understood by those having ordinary skill in the art may be used at any point in the system of the present invention. For example, encryption may be accomplished by encrypting an output file using a Secure Socket Layer (SSL) with dual key encryption. Additionally, the system may limit data manipulation or information access. For example, a system administrator may allow for administration of the system at one or more levels, such as at an individual reviewer, a review team manager, a quality control review manager, or a system manager. Further, the system administrator may also implement access or use restrictions for users at any level. Such restrictions may include, for example, the assignment of usernames and passwords required for the use of the system runs a check for or to implement an adjustment, backend administrative access, associated mobile device apps, or the selection of one or more data types that the subservient user is allowed to view or manipulate.

The processing system 104 may be used to implement the methods described herein that provide adjustments to a financial instrument to adjust a credit offer. Further, the processing system 104 may comprise an input/output (I/O) module 108, a software module 110, a storage module 112, a database 114, a network interface 116, and a processor 118. The I/O module 108 may be used by a system administrator with specialized access that can be used to adjust the credit offer. The I/O module 108 may comprise I/O devices, display devices, or a group of devices may be augmented reality devices. The I/O devices may be controlled by an I/O controller. The I/O controller may control one or more I/O devices, such as e.g., a keyboard and a pointing device, e.g., a mouse or optical pen. Furthermore, an I/O device may also allow storage or an installation medium for the computing device 102. In still other embodiments, the computing device 102 may allow USB connections (not shown) to receive handheld USB storage devices. In further embodiments, an I/O device may be a bridge between a system bus and an external communication bus, e.g., a USB bus, a SCSI bus, a FireWire bus, an Ethernet bus, a Gigabit Ethernet bus, a Fiber Channel bus, or a Thunderbolt bus.

Further, the software module 110 may be utilized by a processor to execute instructions out of a memory. This may include performing calculation according to an algorithm that uses property criteria to adjust a credit offer provided to a borrower. The system 100 for implementing an adjustment may operate as application software, performed by the software module 110, which a local or remote computing device may manage. The software may include a software framework or application architecture that optimizes ease of use of at least one existing software platform and may extend the capabilities of at least one existing software platform. The application architecture may approximate the actual way users organize and manage electronic files and thus may organize use activities in a natural, coherent manner while delivering use activities through a simple, consistent, and intuitive interface within each application and across applications. The architecture may also be reusable, providing plug-in capability to any number of applications without extensive reprogramming, enabling parties outside of the system 100 to create components that plug into the architecture. Thus, software or portals in the architecture may be extensible, and new software or portals may be created for the architecture by any party.

In one embodiment, the system software may also be a portal or software as a service (SaaS) that provides, via the GUI, remote access to and from the system for implementing an adjustment. The software may include, for example, a network browser as well as other standard applications. The software may also include the ability, either automatically based upon a user request in another application or by a user request, to search or otherwise retrieve data from one or more remote points, such as on the internet or from a limited or restricted database. The software may vary by user type or may be available to only a certain user type, depending on the needs of the system 100. Users may have some portions, or all the application software reside on a local computing device or may have linking mechanisms, as understood by those skilled in the art, to link a computing device to the software running on a central server via the communications network, for example. As such, any device having or having access to; the software may be capable of uploading or downloading any information item or data collection item, or informational files associated with such files.

Further, the presentation of data through the software may be in any sort and number of selectable formats. For example, a multi-layer format may be used, wherein the additional information is available by viewing successively lower layers of presented information. Such layers may be made available by using drop-down menus, tabbed folder files, or other layering techniques understood by those skilled in the art or through a novel natural language interface as described herein throughout.

Further, the storage module 112 may be used to store the software or the algorithm to perform a method for utilizing project information to adjust the credit offer of the borrower. It can be noted that the storage module 112 may store one or more instructions and data. The data may be related to at least but not limited to agreement between lender and buyer, loan, lien documents, or loan security documents. The one or more instructions may be instructions that are executable by the processor 118 to perform a specific operation for performing the method for utilizing project information to adjust the credit offer of the borrower. Some of the commonly known memory implementations may include but are not limited to, fixed (hard) drives, magnetic tape, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms (e.g., Microsoft Azure and Amazon Web Services, AWS), or other types of media/machine-readable medium suitable for storing electronic instructions

Further, the database 114 may be used to store data related to the borrower, the credit history, and the current credit of the borrower or the user. Further, the database 114 may be configured to store a systematic collection of data used for electronic storage and data manipulation. In one embodiment, the database 114 may be of various types, such as but not limited to a centralized database, cloud database, and network database. The database 114 may include structured data containing details of the users, including the lender or the borrower, and all other documents related to their agreement. In an embodiment, the database 114 may include the name and address of the lender and borrower, agreement terms and conditions between the lender and the borrower. For example, an address could mean a place, a neighborhood, a parcel of land, or other comparable properties, etc. There are no limitations to the number, type, or connectivity of the database 114 utilized by the system 100.

Further, the system 100 may provide financial and site planning/progress software applications accessible to one or more users, such as different users associated with a user or a financial institution to perform one or more functions. Such applications may be available at the same location or a location remote from the user. Each application may provide a graphical user interface (GUI) and the network interface 116 for ease of interaction by the user with information resident in the system 100 and for facilitating communication of the processing system 104 with the network 106. The network interface 116 may be specific to a user, set of users, or type of user, or may be the same for all users or a selected subset of users. The system software may also provide a master network interface 116 set that allows a user to select or interact with the network interface 116 of one or more other applications, or that allows a user to simultaneously access a variety of information otherwise available through any portion of the system. Further, the network interface 116 may perform signal transmission and distribution functions within the system 100. The network interface 116 may connect electronic devices or computing devices 102-1 . . . 102-N to electrical systems at a control level. Further, the network interface 116 provides many solutions tailored for virtual network deployment and management, which efficiently optimize the distribution and management of virtual workloads and provide maximum scalability and reduced bottleneck impediments to the system 100. The network interface 116 may be easily integrated into existing hardware and architecture and configured to deploy virtual machine device queues. The network interface 116 may be ideally suited for the consolidation of virtual network traffic in the system 100 without departing from the scope of the disclosure.

Further, the processing system 104 comprises the processor 118, which performs the operations run by the software module 110. The processor 118 may be a digital signal controller (DSC) for processing the signals received during the method of adjusting the credit offer. The DSC may be a hybrid of microcontrollers and digital signal processors (DSPs). In other instances, the processor 118 may be a microcontroller to process the control signals received during the adjustment of the credit offer. The processor 118 may be manufactured by different manufacturers such as Microchip, Freescale, and Texas Instruments.

FIG. 2 illustrates a computing device that may communicate with a computer that manages a credit process. Computing device 200 may be the same as computing device 102 that communicates with computer system 100 of FIG. 1. The computing device 200 may include an input and output (I/O) interface 202, a network interface 204, memory 206, a display interface 208, and at least one processor 210. In addition, it can be noted that the operable computer components of the system 100 of FIG. 1 for determining and implementing an adjustment may reside entirely on a single computing device or may reside on a central server and run on any number of end-user devices via a communications network, without departing from the scope of the disclosure.

A user may use the I/O interface 202 to provide project information or user credit offer. The I/O module 108 may comprise I/O devices, display devices, or a group of devices may be augmented reality devices. The I/O devices may be controlled by an I/O controller. The I/O controller may control one or more I/O devices, such as e.g., a keyboard and a pointing device, e.g., a mouse or optical pen. Furthermore, an I/O device may also allow storage or an installation medium for the computing device 102. In still other embodiments, the computing device 102 may allow USB connections (not shown) to receive handheld USB storage devices. In further embodiments, an I/O device may be a bridge between a system bus and an external communication bus, e.g., a USB bus, a SCSI bus, a FireWire bus, an Ethernet bus, a Gigabit Ethernet bus, a Fiber Channel bus, or a Thunderbolt bus

The network interface 204 may, for ease of interaction by the user with information resident in the system 100 and for facilitating communication of the computing device 102 with the network 104. The network interface 204 may be specific to a user, set of users, or type of user, or may be the same for all users or a selected subset of users. The system software may also provide a master network interface 204 set that allows a user to select or interact with the network interface 204 of one or more other applications, or that allows a user to simultaneously access a variety of information otherwise available through any portion of the system. Further, the network interface 204 may perform signal transmission and distribution functions within the computing device 102.

The memory 206 may be used to store data related to the borrower, the credit history, and the current credit of the borrower or the user. Further, the memory 206 may be configured to store a systematic collection of data used for electronic storage and data manipulation. For example, the memory 206 may include structured data containing details of the users, including the lender or the borrower, and all other documents related to their agreement. The memory 206 may include the name and address of the lender and borrower, agreement terms and conditions between the lender and the borrower. There are no limitations to the number, type, or connectivity of the memory 206 utilized by the computing device 102.

The display interface 208 may correspond to output devices including, but not limited to, video displays, graphical displays, speakers, headphones, inkjet printers, laser printers, and 3D printers. In another embodiment, the display interface 208 may correspond to an input/output device like a touch screen, capable of receiving user input. Further, the display interface 208 may be a user device graphical user interface (GUI) or guided user interface(s) that may either accept users' inputs or facilitate outputs to the users or perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may be implemented as a Command Line Interface (CLI), a GUI, a voice interface, or a web-based user interface. For example, the display interface 208 may facilitate users to input data related to credit offers and project information. The display interface 208 may provide notifications in a user-friendly or interactive form to the user.

At least one processor 210 may perform the operations run by the memory 206. Processor(s) 210 may be a digital signal controller (DSC) for processing the signals received during the method of adjusting the credit offer. The DSC may be a hybrid of microcontrollers and digital signal processors (DSPs). In other instances, the at least one processor 210 may be a microcontroller to process the control signals received during the adjustment of the credit offer. Processors discussed herein may be manufactured by different manufacturers such as Microchip, Freescale, and Texas Instruments.

The computing device 200 may include at least one processor 210, I/O interface 202, and all hardware and software typically found on computing devices to store data and run programs and send and receive data over the network 106, if needed. In one embodiment, when a central processing server is used, it may be one server or, more preferably, a combination of scalable servers, providing functionality as a network mainframe server, a web server, a mail server, and central database server, all maintained and managed by an administrator or operator of the system 100. The computing devices 200 may also be connected directly or via a network 106 of FIG. 1 to remote databases, such as for additional storage backup, and to allow for the communication of files, email, software, and any other data formats between two or more computing devices, such as between a mobile user device, client systems, lender systems, and financial institution platforms. Further, the system 100 of FIG. 1 may utilize multiple numbers and various databases utilized by the system 100 without departing from the scope of the disclosure. Finally, the network 106 of FIG. 1 may be a wide area network and may be any suitable networked system understood by those having ordinary skill in the art, such as, for example, an open, wide area network (e.g., the Internet), an electronic network, an optical network, a wireless network, a physically secure network or virtual private network, and any combinations thereof. The network 106 may also include any intermediate nodes, such as gateways, routers, bridges, Internet service provider networks, public-switched telephone networks, proxy servers, firewalls, and the like, such that the communications network may be suitable for the transmission of information items and other data throughout the system 100.

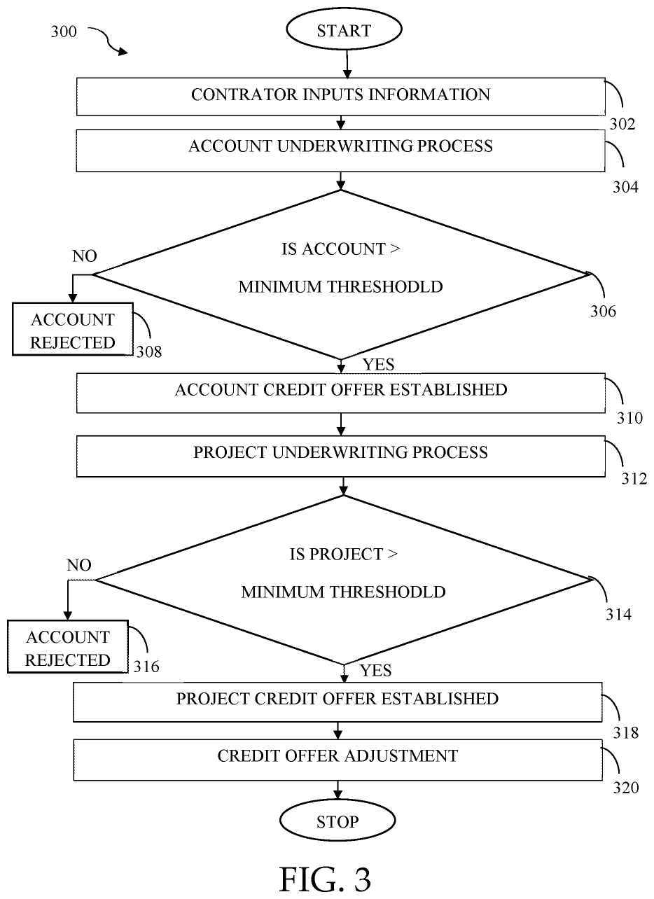

FIG. 3 illustrates a flowchart 300 that includes steps of a method for utilizing project information to adjust a credit offer. It should also be noted that in some alternative implementations, the functions noted in the blocks may occur out of order noted in the drawings. For example, two blocks are shown in succession in FIG. 3A may be executed substantially concurrently, or the blocks may sometimes be executed in the reverse order, depending upon the functionality involved. In addition, the process descriptions or blocks in flowcharts should be understood as representing decisions made by a hardware structure such as a state machine. The flowchart 300 starts at step 302 and proceeds to step 320.

At first, a contractor input information is received by the system 100 of FIG. 1, at step 302. The contractor may apply for credit by inputting a predefined set of information. The input provided by the contractor may be received using the computing device 102 of FIG. 1 or the computing device 200 of FIG. 2. Further, the predefined set of information may include, but may not be limited to, tax identification (ID) number, business owner information, date of birth (DOB), credit required, credit report, credit score, interest rate, term, business report, and project address—place neighborhood, parcel, and comparable properties. For example, for contractor Alex, with tax id—779, DOB—4/5/1789, credit score—826, credit required $9,000,000, and residential property at 31 King Street, Chicago, with project materials to be installed for $10,000,000. Further, the contractor input may correspond to project information and might include property attributes like property type, property use, schedule of improvements, and eligibility for adjustments.

The system 100 of FIG. 1 may perform a credit underwriting process based on the input information at step 304. It can be noted that the underwriting process may be the process by which the lender decides whether the contractor (a user or an applicant) is creditworthy and should receive a loan or credit. Further, the credit underwriting process may be performed by the system 100 or by third-party services connected to the network 106. For example, Mark's credit underwriting process is performed for Alex for the credit requirement of $9,000,000.

Further, the system 100 may determine if the account credit offer is above a minimum threshold at step 306. In one case, if the account credit offer is not above the minimum threshold, then the system 100 may reject the account at step 308. For example, if Alex does not provide a valid tax ID, Alex's account may be rejected. In another case, if the account credit offer is above the minimum threshold, then the system 100 may establish the account credit offer at step 310. Finally, when the account credit offer is above the minimum threshold the account may be approved. For example, for Alex, the minimum threshold requirement of a tax ID and credit score and a minimum credit ask value of $5,000,000 is met, then the account credit offer is approved.

Further, the system 100 may perform a project underwriting process at step 312. A project underwriting process may be related to the property associated with the contractor. It can be noted that the project underwriting process may be the process that involves inputs, including the address for which the assets will remain and the property value of the address. For example, for Alex project underwriting process is performed by Mark, for Alex for the credit requirement of $9,000,000 and property material evaluation of $10,000,000 of Alex's property at 31 King Street, Chicago. Here, assets may be but may not be limited to building materials, and the address may be a building site where the materials will be installed. Further, the project credit offer may be tied to the building site address and property value of that address. The property attributes considered may include one or more of property value, property type (residential vs. commercial), property use, schedule of improvements, government vs. private, and eligibility for adjustments. The project credit offers determinations are also project-specific and cumulative, so as new projects under the account come in, new credit decisions are calculated for the account.

Further, the system 100 may determine if a project credit offer is above a minimum threshold at step 314. For example, for Alex, with credit required for $90,000,000 and property with property material evaluation of $100,000,000, the system determines if the project credit offer is above the minimum threshold. In one embodiment, the lender may determine that the contractor or borrower may have suboptimal credit. In one case, if the project credit offer is not above the minimum threshold, then the system 100 may reject the account at step 316. For example, for Alex, when the credit required is $12,000,000, which is more than the property evaluation value, then Alex's account may be rejected. In another case, when the project credit offer is above the minimum threshold, then the system 100 may establish the project credit offer at step 318. For example, for Alex, if the credit required is $9,000,000, which is less than the property evaluation value, then Alex's account is approved, and a project credit offer is established.

Based on the established project credit offer and the established account credit offer, the system 100 may perform a credit offer adjustment at step 320. For example, for Alex, based on the credit requirement of $9,000,000 and property material evaluation of $10,000,000, an additional credit offer adjustment of $1,000,000 is made. It can be noted that the system may recalculate the project credit offer based on the addition of a new project. For example, for Alex, with a new project of $50,00,000, the project credit is recalculated to $150,00,000.

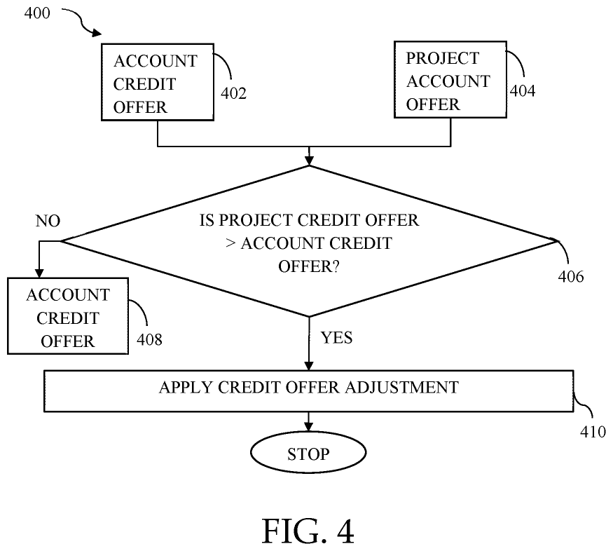

FIG. 4 illustrates a flowchart 400 showing a method for determining an eligibility to receive a credit offer adjustment. It should also be noted that in some alternative implementations, the functions noted in the blocks may occur out of order noted in the drawings. For example, two blocks shown in succession in FIG. 4 may be executed substantially concurrently, or the blocks may sometimes be executed in the reverse order, depending upon the functionality involved. In addition, the process descriptions or blocks in flowcharts should be understood as representing decisions made by a hardware structure such as a state machine. The flowchart 400 starts at step 402 and proceeds to step 410.

At first, the account credit offer may be received at step 402. For example, for contractor Alex, with tax ID—779, DOB—4/5/1789, credit score—826, the account credit offer received is $90,000,000. Further, the project account offer may be received at step 404. For example, for contractor Alex, with tax id—779, DOB—4/5/1789, credit score —826, a residential property at 31 King Street, Chicago, with a project account offer of $100,000,000.

Further, the system 100 of FIG. 1 may determine if the project credit offer is more than the account credit offer at step 406. In one case, if the project credit offer is not more than the account credit offer, then the system 100 may set the account credit offer to the project credit offer at step 408. For example, for a project credit offer of $7,000,000, then count credit offer of $9,000,000 is also set to $7,000,000. In another case, if the project credit offer is more than the account credit offer, then the system 100 may apply the credit offer adjustment at step 410. For example, for contractor Alex, with tax id—779, DOB—4/5/1789, credit score—826, a residential property at 31 King Street, Chicago, with account credit offer received is $9,000,000 and the project account offer of $10,000,000, the account credit offer is set to $10,000,000, with an adjustment multiple of $1,000,000. Here, the adjustment multiple may be based on a percentage of the value of new projects that come in. For example, if a summation of the project credit offer is different than the account credit offer, then the contractor may receive an adjustment. In other instances, the system 100 may offer adjusted credit based on the ability of the client to attract more valuable projects. Further, a part of the property research and attributes evaluated may be used as a criterion for credit adjustment eligibility.

The system and method for utilizing a lien to implement an adjustment may also include standard reporting mechanisms, such as generating a printable receipt of the transaction or electronic results report that can be transmitted to any communicatively connected computing device, such as a generated email message or file attachment. Likewise, particular results of the system transaction can trigger an alert signal, such as the generation of an alert email, text, or phone call, to alert a user, financial institution, or person associated with the user or financial institution.

The subject disclosure describes a method for utilizing project information to adjust the credit offer. It can be noted that the system 100 of FIG. 1 and method according to one embodiment may execute the method and algorithms for implementing an adjustment to a financial instrument which can include one or more local or remote executable software platforms, mobile device platforms, or a hosted Internet or network program or portal. In one embodiment, only portions of the system are computer operated, and in other embodiments, the entire system is computer operated. In one embodiment, client users may run an application on their mobile devices so that the system 100 can be easily accessed in real-time at a construction site. The system and method for utilizing a mechanic's lien for implementing an adjustment is fully integrated for use with any additional platform and data output that may be used to communicate with other platforms, such for example, financial institution platforms, user information platforms, cyber security platforms, and payment collection platforms.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. It will be appreciated by those skilled in the art that changes could be made to the exemplary embodiments described above without departing from the broad inventive concept thereof. Therefore, it is to be understood that this disclosure is not limited to the particular embodiments disclosed, but it is intended to cover modifications within the spirit and scope of the subject disclosure as disclosed above.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims.

What is claimed is:

1. A method for utilizing project information to adjust a credit offer, the method comprising:
establishing an account credit offer based on client information;
establishing a project credit offer based on project information, the project information including a project address;
generating an adjustment multiple when the project credit offer is different than the account credit offer; and
changing the account credit offer based on the project credit offer and the adjustment multiple.

2. The method of claim 1, wherein the project address includes the address for which assets purchased by the credit offer will be installed.

3. The method of claim 2, wherein the assets comprise building materials.

4. The method of claim 1, wherein the project information includes property attributes.

5. The method of claim 4, wherein the property attributes include one or more of property value, property type, property use, schedule of improvements, and eligibility for adjustments.

6. The method of claim 1, wherein the project credit offer is based on a summation of a plurality of projects.

7. The method of claim 1 further comprising recalculating the project credit offer based on the addition of a new project.

8. The method of claim 1, wherein the step of establishing an account credit offer is based on contractor input information.

9. The method of claim 8, wherein the contractor inputs information, includes one or more of a tax identification (ID) number, business owner information, date of birth, a credit report, a business report, and an address.

10. The method of claim 9, wherein the step of establishing an account credit offer is based on an evaluation of the contractor input information exceeding a pre-set minimum threshold.

11. A non-transitory computer readable storage medium having embodied thereon a program executable by a processor for implementing a method for utilizing project information to adjust a credit offer, the method comprising:
establishing an account credit offer based on client information;
establishing a project credit offer based on project information, the project information including a project address;
generating an adjustment multiple when the project credit offer is different than the account credit offer; and
changing the account credit offer based on the project credit offer and the adjustment multiple.

12. The non-transitory computer readable storage medium of claim 11, wherein the project address includes the address for which assets purchased by the credit offer will be installed.

13. The non-transitory computer readable storage medium of claim 12, wherein the assets comprise building materials.

14. The non-transitory computer readable storage medium of claim 11, wherein the project information includes property attributes.

15. The non-transitory computer readable storage medium of claim 14, wherein the property attributes include one or more of property value, property type, property use, schedule of improvements, and eligibility for adjustments.

16. The non-transitory computer readable storage medium of claim 11, wherein the project credit offer is based on a summation of a plurality of projects.

17. The non-transitory computer readable storage medium of claim 11, the program is further executable to recalculate the project credit offer based on the addition of a new project.

18. The non-transitory computer readable storage medium of claim 11, wherein the step of establishing an account credit offer is based on contractor input information.

19. The non-transitory computer readable storage medium of claim 18, wherein the contractor inputs information, includes one or more of a tax identification (ID) number, business owner information, date of birth, a credit report, a business report, and an address.

20. An apparatus that uses project information to adjust a credit offer, the apparatus comprising:
a memory; and
a processor that executes instructions out of the memory to:
establish an account credit offer based on client information,
establish a project credit offer based on project information, the project information including a project address,
generate an adjustment multiple when the project credit offer is different than the account credit offer, and
change the account credit offer based on the project credit offer and the adjustment multiple.
